(19) United States
(12) Patent Application Publication
(10) Pub. No.: US 2024/0233690 A1
(43) Pub. Date: Jul. 11, 2024

(54) CLIP ON MUSICAL INSTRUMENT ACCESSORY BAG

(71) Applicants: Michael Jarosz, Moorestown, NJ (US); Elena Jarosz, Moorestown, NJ (US)

(72) Inventors: Michael Jarosz, Moorestown, NJ (US); Elena Jarosz, Moorestown, NJ (US)

(21) Appl. No.: 18/308,316

(22) Filed: Apr. 27, 2023

Related U.S. Application Data
(63) Continuation-in-part of application No. 29/882,070, filed on Jan. 10, 2023, now abandoned.

(51) Int. Cl. G10G 7/00

(52) U.S. Cl. CPC G10G 7/005; A45C 2013/026

(57) ABSTRACT

A musical instrument accessory bag has an internal cavity defined by a rectangular bottom panel a rear sidewall, a left sidewall, a right sidewall, and a front sidewall and a folding lid joined to the rear sidewall at a joint. Clips integrated into the folding lid clip to a tray of a music stand when the lid is open. A retaining strip attached to the rear sidewall, straps around the music stand shaft. The bag conveniently stores, protects, and transports musical instrument accessories.

### CROSS-REFERENCE TO RELATED APPLICATION

This application is a continuation in part of U.S. application Ser. No. 29/882,070, filed Jan. 10, 2023, the contents of which are herein incorporated by reference.

### BACKGROUND OF THE INVENTION

The present invention relates to musical instrument accessory containers and, more particularly, to a clip on musical instrument accessory bag.

Musicians often need to bring accessories to a performance. For example, a musician can transport and store trumpet mutes in a bag or case, arrive at a performance, and transfer the mutes to a mute holder. The bag needs to be put somewhere out of the way.

As can be seen, there is a need for a means to conveniently store and transport music instrument accessories and utilize the items without having to stow the carrier or bag.

### SUMMARY OF THE INVENTION

In one aspect of the present invention, a musical instrument accessory bag comprises a rectangular bottom panel with a rear sidewall, a left sidewall, a right sidewall, and a front sidewall rising therefrom, collectively defining an internal cavity operative to accommodate and enclose musical instrument accessories; a folding lid joined to the rear sidewall at a joint; clips integrated into the folding lid, the clips operative to clip to a tray of a music stand when the folding lid is open; and a retaining strip affixed to the rear sidewall, the retaining strip being operative to removably strap around a shaft of the music stand.

The music instrument accessory bag conveniently stores, protects, and transports musical instrument items. Clips integrated into the lid enable the musician to attach the bag to the tray of a music stand.

These and other features, aspects and advantages of the present invention will become better understood with reference to the following drawings, description, and claims.

### BRIEF DESCRIPTION OF THE DRAWINGS

FIG. 1 is a perspective view of a music accessory bag according to an embodiment of the present invention;

FIG. 2 is another perspective view thereof, shown in use;

FIG. 3 is a rear bottom perspective view thereof;

FIG. 4 is an exploded view thereof;

FIG. 5 is a sectional view thereof, taken along line 5-5 in FIG. 2; and

FIG. 6 is a detailed sectional view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a music instrument accessory bag that attaches to a music stand.

A retaining strip or strap on the back of the bag with fasteners, such as Velcro® hook-and-loop closures, may be strapped around the music stand to prevent the bag from swinging.

Clips in the lid of the bag may be attached onto the tray of a music stand.

The clips may be injection molded, inserted into slots in the lid of a manufactured bag. They may then be screwed in from the other side. The Velcro® strap may be sewed into the back of the bag.

The bag may be used to store and transport accessories, such as trumpet mutes, and may be attached to a music stand at a performance. The accessories are then readily and easily available for the musician to use. At the end of the performance, the bag may be removed from the stand and zipped up, ready for transport.

In some embodiments of the present invention, the bag is a musical instrument accessory bag with a folding lid, having an internal cavity formed from a rectangular bottom panel with a rear sidewall, a left sidewall, a right sidewall, and a front sidewall.

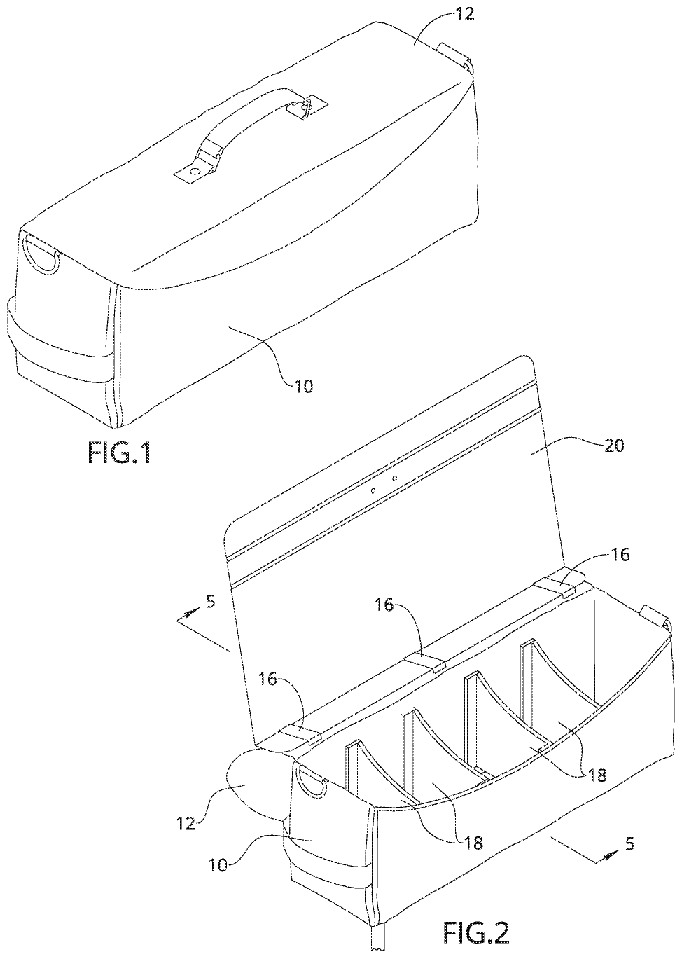

Referring to FIGS. 1 through 6, FIG. 1 illustrates an accessory bag 10 according to an embodiment of the present invention including a lid 12 with a centrally located handle, a ring or attachment point near the top for attachment of a strap and a handle affixed to the side end.

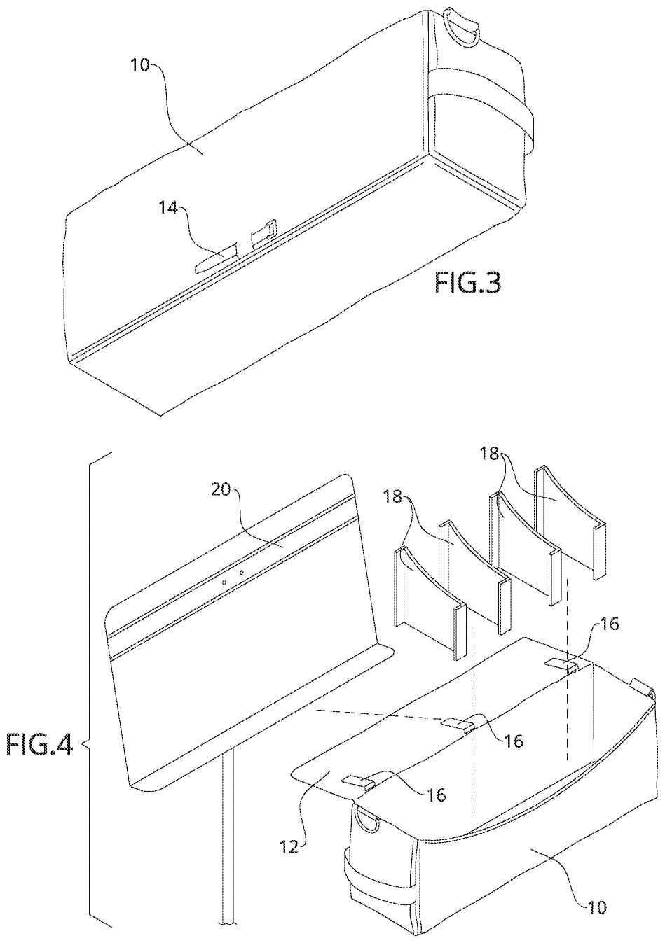

As show in FIGS. 2 and 4, The bag 10 has spaced apart removable vertical dividers 18 that segment the internal cavity into storage compartments to organize components stored therein. The bag 10 is shown in FIGS. 2 and 6 with the lid 12 folded back so that multiple clips 16 affixed to the lid 12 may be attached to a music stand 20 tray.

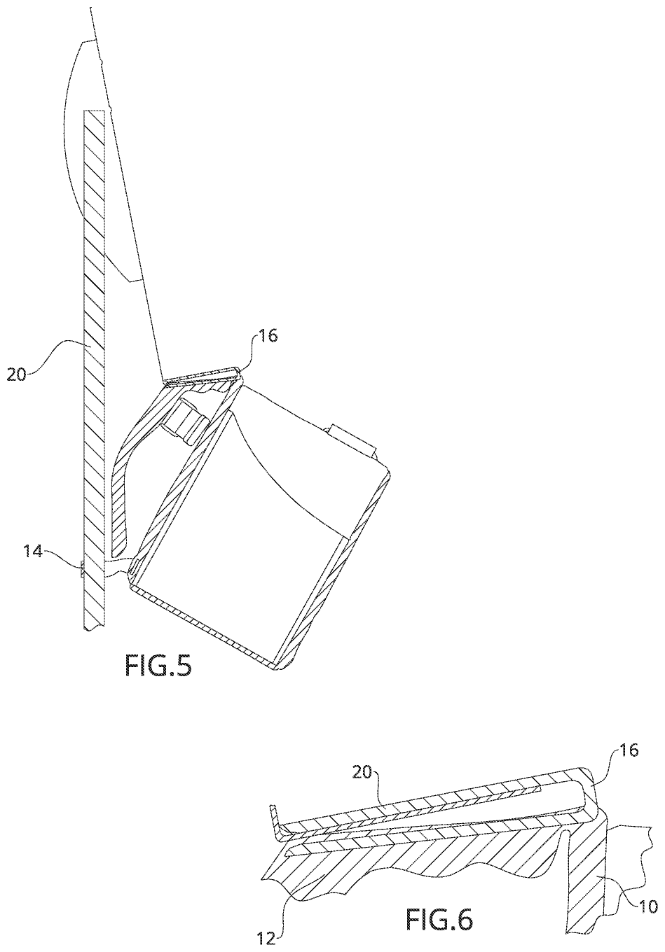

The lower rear of the bag has a retaining strap 14 which may be used to attach the bag 10 to the music stand 20 shaft; see FIGS. 3 and 5.

It should be understood, of course, that the foregoing relates to exemplary embodiments of the invention and that modifications may be made without departing from the spirit and scope of the invention as set forth in the following claims.

What is claimed is:

1. A musical instrument accessory bag, comprising:
a rectangular bottom panel with a rear sidewall, a left sidewall, a right sidewall, and a front sidewall rising therefrom, collectively defining an internal cavity operative to accommodate and enclose musical instrument accessories;
a folding lid joined to the rear sidewall at a joint;
clips integrated into the folding lid, the clips operative to clip to a tray of a music stand when the folding lid is open; and
a retaining strip affixed to the rear sidewall, the retaining strip being operative to removably strap around a shaft of the music stand.

2. The musical instrument accessory bag of claim 1, further comprising spaced apart removable vertical dividers within the internal cavity, operative to segment the internal cavity into storage compartments.

3. The musical instrument accessory bag of claim 1, wherein the folding lid has a centrally located handle on an exterior surface thereof.

4. The musical instrument accessory bag of claim 1, wherein the left sidewall and the right sidewall have attachment points adjacent to an opening of the internal cavity, operative to couple to a shoulder strap.

5. The musical instrument accessory bag of claim 1, wherein at least one of the left sidewall and the right sidewall further comprises a handle.
